(19) United States
(12) Patent Application Publication
(10) Pub. No.: US 2022/0291418 A1
(43) Pub. Date: Sep. 15, 2022

(54) AN INTEGRATED GEOMECHANICS MODEL FOR PREDICTING HYDROCARBON AND MIGRATION PATHWAYS

(71) Applicant: Abu Dhabi National Oil Company, Abu Dhabi (AE)

(72) Inventor: Abdelwahab NOUFAL, Abu Dhabi (AE)

(21) Appl. No.: 17/636,281

(22) PCT Filed: Sep. 12, 2019
(86) PCT No.: PCT/IB2019/057694

§ 371 Date: Feb. 17, 2022

(51) Int. Cl. G01V 99/00; G01V 1/30

(52) U.S. Cl. CPC G01V 99/005; G01V 1/302; G01V 1/306; G01V 2210/6169; G01V 2210/6224; G01V 2210/6242; G01V 2210/6244; G01V 2210/6246; G01V 2210/6248; G01V 2210/642; G01V 2210/646

(57) ABSTRACT

The present invention relates to a method of prediction of hydrocarbon accumulation in a geological region comprising the following steps of: a. Generation of a geological basin model; b. Generation of a geomechanical model; c. Generation of an integrated model; d. Generation of a strain map based on the information obtained in steps a to c; e. Prediction of hydrocarbon accumulation from the strain maps.

### 1. TECHNICAL FIELD

The present invention relates to a method of prediction of hydrocarbon accumulation in geological regions. Such a prediction can be used to improve oil and gas production by predicting the location of hydrocarbon accumulations and the migration trajectories, and accordingly provides a useful tool for exploration and Field Development Plan (FDP).

### 2. BACKGROUND OF THE INVENTION

The present invention relates to the field of predicting the location of hydrocarbon accumulations. Occurrence and movement of said accumulations is dependent on the geological formation of the multitude of geological layers of the respective geographic region, as well as the respective physical and geological properties of the region. Since drilling of a well for the hydrocarbon exploitation is expensive, several approaches were developed in the art how to simulate and predict the occurrence of hydrocarbon accumulations. In said approaches, different simulation techniques are employed.

Reference document WO 2010/120492 A2 relates to a computer implemented method for conducting a geologic basin analysis in order to determine the accumulation of hydrocarbons in a subsurface region of interest. The method includes defining a basin analysis project relating to at least one basin within a subsurface region of interest using project scoping data and geological and geophysical data related to the subsurface region of interest in an integrated computer environment having at least a graphical user interface and multiple basin analysis workflows; each basin analysis workflow having user selectable tasks. The method further includes applying at least one basin analysis workflow to the basin analysis project and performing user selected tasks in the integrated computer environment, to carry out a basin analysis including determining the basin characteristics, geological trends and the likelihood of a hydrocarbon system; wherein the use of the basin analysis workflow is based upon the volume of data provided by the user through the performance of the selected tasks and the basin analysis project scoping data.

Reference document U.S. Pat. No. 7,054,753 B1 relates to a method of locating oil and gas drilling prospects utilizing an unprecedented quantity of digital well log data, well production histories, well test data, and any other relevant digital well data. The method is comprised of obtaining, then digitizing on a computer or other suitable digitizing apparatus, log data from a plurality of wells drilled in a desired oil and gas basin; then normalizing the log data from each well using a standardized scale; correlating each digitized well log to create a stratigraphic framework for the entire basin; and, identifying the observable depositional features and facies for each interval in each well. The method also encompasses visually displaying a plurality of individual well logs to reveal consistent depositional characteristics of a cross-sectional area of a portion of the basin.

However, there is a need for an improved method of predicting hydrocarbon accumulation occurrences and movements.

Thus, it is an object of the invention to provide an improved method of prediction of hydrocarbon accumulation in geological regions.

The above-mentioned problems are at least partially be solved by a method of prediction of hydrocarbon accumulation in a geological region comprising the following steps of:
a. Generation of a geological basin model;
b. Generation of a geomechanical model;
c. Generation of an integrated model;
d. Generation of a strain map based on the information obtained in steps a to c;
e. Prediction of hydrocarbon accumulation from the strain maps.

A spatial and temporal prediction of hydrocarbon accumulation can be achieved. A geographical field's map is overlaid with the strain map and/or the map of the hydrocarbon accumulation. Accordingly, a spatial correspondence between the spatial strain map and/or the map of the hydrocarbon accumulation and a geological region can be established. Hence, a distinct position for drilling can be obtained and costly drillings at several positions can be avoided.

In a preferred embodiment, the geological basin model further comprises at least one of the following steps of:
a. Determination of Horizons and faults;
b. Restoration and backstripping to identify the tectonic events;
c. Modeling porosity;
d. Modeling pressure;
e. Modeling Porosity-permeability relationship.

The present invention provides a modified basin model to include all the geologic features and based on a structural restoration for applying the tectonic events due time. Prediction of pore pressure and porosity in a resource assessment area was performed by using Petroleum Systems Modeling techniques, combining seismic and well data and geological knowledge to model sedimentary basin evolution. The objective of this phase is to create a basin history including geological structures as a basis for the next phase to feed the geomechanical model (cf. FIG. 1). Horizons (also referred to as surfaces) and faults were interpreted from seismic data and derived from isopach maps. These maps were used to construct the basin model that was built from the top surface sediment down to reservoirs. The evolution of porosity, pore pressure, temperature and thermal maturity through time were simulated and calibrated to measured data.

In the present invention, the existing 3D interpretation and structural models can be validated using the forward modeling and restoration tools. The results give the geometry and timing of fault movement and this implicates all subsequent basin-modeling steps. In the present invention a regional scale 3D restoration, for example, of the larger Abu Dhabi area is carried out and the geological strain through time is captured using the geometric and the geomechanical algorithms to analyze the strain at different time steps during the tectono-stratigraphic evolution of, for example, the Abu Dhabi basins. The simulation results provide the estimated porosity and pore pressure in the play, as well as the reconstruction of the overall basin geometry through time. The resulting models were subsequently used as the basis for further fracture prediction phase; results were ultimately consistent with faults derived from existing seismic interpretation. Model porosity, pore pressure and predicted fractures were used for the development of static geological and dynamic reservoir models. The use of petroleum system modeling technology was crucial to reconstruct palaeo-geometry of a basin and its effects on geological evolution such as porosity and pressure. Geological knowledge such as present day basin geometry and age of the formation must be acquired prior to the reconstruction of the basin geometry. During model simulation steps, the model was backstripped to the oldest formation (cf. FIG. 2).

Chilingarian & Wolf (1975) study the porosity-permeability relationship where the authors found that the permeability of isotopic sediments is controlled by its porosity and grain size distribution. A further study by Tissot and Welte (1984) shows that with further compaction, porosity at shallower depth will lose rapidly. However, the rate of porosity loss diminishes with increase in pressure. To predict pressure, the porosity-permeability relationship, piecewise linear function in permeability versus porosity graph was used to control pressure model.

In a preferred embodiment, the step of modeling pressure further comprises at least one of the following steps of:
a. Calibration of the pore pressure model;
b. Application of the pore pressure model to the geological region.

Model porosity is dependent on burial depth, weight of the overburden sediment columns and lithology properties. Porosity calibration was achieved by adjusting the compaction curve to effective stress. Pore pressure was calibrated by adjusting lithology porosity-permeability relationships. Low permeability lithologies result in high pore pressure. Lithology and/or facies for each of the formation needed to be defined correctly. Lithology parameters such as mechanical compaction and permeability were unique for each formation. These parameters control the deformation and compaction behavior of each formation layer at all geological ages during simulation. In defining the boundary conditions, paleowater depth, sediment-water interface temperature and heat flow were important to constrain the geometry and thermal evolution of the basin at every given geological age.

In a preferred embodiment, the geological basin model comprises mechanical stratigraphy. In a preferred embodiment, the geological basin model comprises the step of modeling permeability.

In a preferred embodiment, the geological basin model further comprises at least one of the following steps of:
a. Sediment decompaction;
b. Acquisition of burial history of the geological region.

Sediment decompaction was modelled allowing the reconstruction of the formation structures through time. Athy (1930) first described a simple porosity-depth relationship. According to the author, porosity Φ will decrease exponentially with depth with a compaction factor k. Smith (1971) refined this definition and proposed to use effective stress rather than total depth in the compaction calculation. Athy's law, formulated with effective stress was used in the forward modeling simulator for the calculation of pore pressure. Information such as formation ages, erosional events and hiatus periods were taken into account during simulation.

In a preferred embodiment, the geological basin model comprises the step of modeling overpressure of the geological region. Formation overpressure is observed at greater depth, which modeling depends on the evolution of connate water vectors over geological time. These vectors depend on multiple lithology parameters as well as the capillary entry pressure of adjacent model layers.

In a preferred embodiment, the generation of a geomechanical model comprises at least one of the following steps of:
a. Seismic Inversion and detailed rock physics analysis including fluid substitution modelling;
b. Pre-stack Seismic Data conditioning;
c. Pre-stack AVO simultaneous inversion;
d. Prediction of mechanical properties based on porosity correlations derived from core results;
e. Generation of a 1D geomechanical model.

This mainly includes 1D geomechanical steps based on logs that were calibrated with Rock Mechanics Testing (RMT), whenever available. Then a 3D Geomechanics model was created that is based on porosity and seismic inversion elastic parameters delivered by a rock physics model. The first stage is the seismic inversion, the 1D Geomechanics models and the 3D model. Seismic data provides the best high-resolution spatial measurement, which was then used to construct structural framework as well computing an accurate 3D property model. Pre-stack seismic inversion enable the computation of the rock mechanical properties e.g. Poisson's ratio, from seismic data which was used as an input in to the 3D geomechanical modelling. This step includes detailed rock physics analysis including fluid substitution modelling, Pre-stack Seismic Data conditioning and pre-stack AVO simultaneous inversion. The technical details of the above options are given below.

Pre-Stack AVO Simultaneous Inversion

The data required to conduct the AVO inversion are listed below:

Well Data:
Standard E-logs (sonic, shear sonic and density) for the selected wells in LAS format,
Formation tops and markers for the selected wells in ASCII format,
Petrophysical evaluation for the selected wells in LAS format,
Check shot data for the selected wells in LAS format,
Processed VSP corridor stack in SEGY format plus processing report for the selected wells,
Well locations and deviation survey for the selected wells in ASCII format (Vertical well away from major faults are more suitable),
Reservoir fluid parameters: pressure, temperature, formation water salinity, Gas water ratio, Gas gravity, etc.
Any other information pertinent to well data processing.

Seismic Data:
Angle stacks (minimum near, mid and far) corrected to proper datum in SEGY format
Seismic velocities (same datum as seismic data) in SEGY format,
Acquisition and processing reports.

Rock Physics

Sonic velocities in reservoir formations change as a function of rock lithology/mineralogy, porosity, pore types, clay content, fluid saturation, stresses, temperature and frequency at which the measurements are carried out. Rock physics analysis is used to evaluate and understand the effect of lithology, porosity, and fluid on sonic velocities and density.

Well Log Conditioning and Field-Wide Data Consistency

Detailed well log editing and depth-to-time conversion was performed on the selected well starting from raw field logs where possible. Emphasis was placed upon testing sonic and density log reliability by reference to adjacent well log portions which are less affected by bad hole conditions and the process of fluid invasion (i.e. Gamma Ray, resistivity and neutron porosity logs). Multivariate statistical parameter regression based on correlation with other correlation logs is used to edit bad log zones. Unreliable depth intervals was analyzed and, edited using a range of statistical, empirical and multi-log/multi-well data substitution techniques, as shown below. Checkshot and VSP data were evaluated and edited as required before calibration of the sonic log to generate a depth-to-time conversion function. Well acoustic impedance (in time domain), was tested to ensure that it provides a correct measurement of rock acoustic properties over the length of the logged borehole and is correctly calibrated to borehole seismic. This involves objective comparison with surface and borehole seismic. In the event of discrepancies, the method iterates through a data validation and editing cycle until the well logs and time-to-depth function are considered to reach optimum reliability. Final edited logs are plotted versus depth for all wells in the area of study for field-wide data consistency. Anomalous well/s out of field data trend is to be investigated. There may be a valid geological reason for anomalous well(s). If not, correction need to be made early in the study to correct bad data and make it field-wide consistence.

Petro-Elastic Analysis

A detailed petro-elastic analysis using the data for selected wells was performed to determine whether significant correlation exists between elastic properties (Acoustic Impedance, Poisson's Ratio, and Density) and petrophysical data (e.g. Porosity).

Angle Stacks Alignment

Proprietary algorithm called Non-Rigid Matching (NRM) could be used to align angle stacks or flatten NMO (this expression for the NMO velocity of the P-wave is valid for any strength of the anisotropy, Tsvankin (1997)), corrected angle gathers, thereby removing any residual NMO and possible anisotropy effects. In anisotropic media, the velocity of the seismic wave varies with the angle of propagation, while NMO velocity is calculated for the zero-offset point. The idea is to calculate the ray velocity along each ray applying the anisotropic ray tracing algorithm and estimate the NMO correction for every ray. NRM does a sample by sample stretch and squeeze, essentially aligning any number of traces to a reference trace. In general a near offset stack trace is computed and each trace in the gather is matched to it, either directly or recursively. NRM thus attempts to flatten all events; it is neither horizon nor move out driven. Better alignment of the events in the angle gathers should result in more reliable AVO (amplitude variation with angle, which means that amplitude change with offset caused by lithology of fluid. AVO is also known as AVA (amplitude variation with angle) because this phenomenon is based on the relationship between the reflection coefficient and the angle of incidence) attributes, in particular for higher angle applications (3-term AVO).

Wavelet Estimation

The wavelet estimation is performed to estimate a wavelet from each one of the input angle stacks seismic data using well elastic data. The wavelets are estimated from the seismic traces and the well reflectivity. The well reflectivity were calculated via Aki and Richards' approximation. Wavelet estimation with various time windows as well as various multi-well scenarios were tested. The results of wavelet estimation were quality controlled using well-seismic composite displays and match statistics, in addition different wavelets were tested through an inversion in order to select the optimum wavelet.

Low Frequency Modelling

Seismic reflection data is band limited from both sides of the spectrum due to acquisition geometry. The lower side of the missing spectrum is very important. Therefore, all seismic inversion schemes (post-stack or pre-stack) in the industry require Low Frequency Model (LFM) in order to compute the full-band elastic properties for direct comparison and calibration with well logs. Moreover, the accuracy of inverted elastic attributes (AI (Acoustic Impedance), Vp/Vs (Vp and Vs: compression and shear velocity) and density) from seismic inversion depends on the accuracy of LFMs. Therefore, it is of paramount importance to make sure that LFMs are as accurate as possible particularly within the inter-well space. A low-frequency model was derived for each attribute (AI, Vp/Vs and density) by extrapolating the appropriate logs, using the interpreted horizons as guide, followed by low-pass filtering. The low-frequency model may also be constrained by seismic velocities, such as stacking or migration velocities, seismic attributes like relative AI volumes, depth trends, and dips estimated from the seismic data and/or observed stratigraphic relationships.

Global Simultaneous AVO Inversion

A Global Simultaneous AVO inversion was used to perform the simultaneous inversion. Direct handling of the frequency and phase differences between the partial stacks through use of a separate wavelet for each partial stack ensures that maximum resolution results are obtained for each layer property, e.g. Poisson's ratio has higher resolution than the far partial stack. There is no need for frequency balancing or special phasing of the seismic data before inversion. The high-frequency variation in reflection angle, e.g. at a high- or low-velocity layer, were estimated during the simultaneous AVO inversion from the estimated acoustic impedance, Vp/Vs and density (density is dependent on available angle range in the input seismic) to give more accurate estimates of the layer properties (cf. FIG. 11). Extensive inversion testing and validation against the selected well log data were performed before full inversion production to select best:
wavelets,
inversion parameters.

In reservoir zones, the prediction of mechanical properties is based on porosity correlations derived from core results (cf. FIG. 12).
Porosity cubes sourced from reservoir models;
In overburden and dense units separating reservoir zones, the prediction of mechanical properties is based on co-kriging upscaled well logs;
Mechanical property profiles sourced from 1D Geomechanics models.

Generation of a 1D Geomechanical Model

Many 1D models created were, for example, constructed for Abu Dhabi fields (cf. FIG. 13), and the log-derived mechanical properties and stresses in the 1D models were used for 3D geomechanical model construction. The entire models were calibrated whenever RMT data was available. The lab testing results were revisited to link/tie to Seismic Inversion output for seismic driven geomechanics property modelling. The procedure of new additional well 1D Geomechanics model construction consists of:
Collate, review and validate input data from the offset well(s);
Load and QC available log data;
Identify and characterize stress-induced wellbore events to time, depth and mud weight used;
Construct rock elastic and strength property models for the overburden and reservoir sections using available log and core test data.
Use the most appropriate correlations to establish log-derived elastic and rock strength property profiles (cf. FIG. 14). The correlations were driven by the rock mechanics test results and combined with new extra laboratory core tests (if performed);
Estimate pore pressure profiles in the well. The determination utilized density, sonic and resistivity logs, local correlations, MDT (Modular Formation Dynamics Tester) and DST (Drill Stim Test) data, etc., if any, and constrained with available pore pressure data;
Determine orientation of horizontal stress direction using available image of hydraulic fractures induced during drilling or minifrac, and/or oriented caliper data, if any;
Develop continuous profiles of principal in-situ stresses showing the magnitudes of overburden stress and, maximum and minimum horizontal stresses. The determination of the horizontal stress magnitude utilized the poro-elastic horizontal strain model. The horizontal stress magnitudes were calibrated with good quality LOT (Leak of Test)/ELOT (Extended Leak off test) data, and rigorously validated against back-analysis of wellbore breakout and drilling-induced fractures observed on image logs and breakout analysis on caliper logs (if available). The data utilize included density and sonic logs, LOT/ELOT data, image logs, caliper logs, daily drilling reports, daily mud reports, end of well reports, structural geology and local correlations and knowledge;
Validate the geomechanics models through rigorous history matching with image logs, drilling experience, field observations and measurements, and test data from the well;
Based on the available models for the different reservoirs, the RMT samples were selected to fill any gap for calibration for the integrated model;
The next step includes the characterization of the rock heterogeneity at both the core and log scales, and completion quality assessment (based on mechanical anisotropic elastic properties, minimum horizontal stress estimates, and rock-fluid interactions);
Characterize the vertical heterogeneity of the integrated reservoirs rock formations;
Improve the resources definition by measuring and modelling critical reservoir properties (porosities, permeabilities, pore space constituents, among others);
Enhance the resource recovery by quantifying the mechanical behavior of the reservoirs and surrounding rock formations, and by determining the rock-fluid interaction parameters required to understand the fluid behavior;
Perform a new testing campaign to better characterize high-porosity carbonate mechanical behavior;
Gather high-quality horizontal stress values and this requires performing microfrac testing in vertical wells together with pore pressure measurement (before microfrac testing) and Borehole image (BHI) logging (both before and after microfrac testing);
Evaluate fault material properties (cf. the red boxes in FIG. 1, see below);
Characterize fractures by re-analyzing all BHI logs and by performing shear testing on cores;
Perform a dedicated cased-hole integrity analysis;
Perform blind tests to validate the previous models;
Enhancement processing and Interpretation of borehole image log (cf. FIG. 15).
Loading, processing and QC of image log data. The image log data to be assessed for depth match against a definitive open hole log set and orientated within the borehole reference frame;
Perform a quality assessment of the image data provided. This involves assessment of the orientation data provided to ensure correct feature orientation, a check of the degree of non-geological image and logging artefacts and their impact on the level of utility for geological analysis;
Manual picking for all Geological features using a sine-curve fitting technique; Lithology and type for sedimentary bedding features and using structural descriptors for faults, fractures, categorized picks and deformation related features including soft sediment deformation. Drilling induced features were also be picked and orientated. Picks were given a confidence rating.
Structural interpretation—Following generation of the manual dip pick data set, a detailed structural analysis was undertaken to define the overall structural geometry described by lithological bedding and to recognize any folding, faults or other deformation that may not be directly imaged. This analysis characterized bulk trends and relationships of faults, allow fracture density changes, and stress changes associated with faulting to be identified. In detail structural analysis involved the following steps:
Subdivision of the depth interval examined based on geological structure (e.g. recognition of fracture styles and orientation, structural dip zones, fault compartments, unconformities etc.);
This is completed using visual dip assessment, vector azimuth plots, and stereonets plots;
Identification and orientation of structural features. Recognition and tabulation of unconformity and fault zones, fractures and deformed intervals;
Fault zones are characterized based on depth, orientation, strike, rotational axes, lithology, presence or absence of drag zones and likely widths of associated damage. Where possible, sense of slip was inferred;
Within each well, structures were analyzed to ensure a clear understanding of wellbore orientation to image features.

In a preferred embodiment, the prediction of mechanical properties based on porosity correlations derived from core results further comprises at least one of that:
a. Porosity cubes are sourced from reservoir models;
b. In overburden and dense units separating reservoir zones, the prediction of mechanical properties is based on co-kriging upscaled well logs; and
c. Mechanical property profiles are sourced from 1D-geomechanics models.

In a preferred embodiment, the method of prediction of hydrocarbon accumulation in a geological region further comprises the step of creating a structural model, wherein the method further comprises the step of estimating 3D static and dynamic of the geomechanics model. In a preferred embodiment, the method of prediction of hydrocarbon accumulation in a geological region further comprises the step of a fault and fracture analysis.

Some formations show a strong indication that natural fracture networks are likely to exist within these reservoirs. Attempts were made to develop a multi-scale fracture model for each of the formations with the objective of incorporating into a 3-D geomechanical model.
The fracture model was built by integrating all well petrophysical data, image log data, geomechanical data, core data, seismic data and well test data of all wells drilled at the time of the start of the project. The following assumptions and workflow were applied:
A 3D geological model exists for the matrix model. As the DFN (Discrete Fracture Network) cannot be upscaled to a very fine geological model, if the geological model is very fine, an upscaled model for flow simulation was needed for building and upscaling the DFN-based fracture model.
Only the wells for which fracture has been interpreted from image logs were used for building the DFN.
If fracture aperture interpretation has been done in wells with BHI logs by advanced fracture interpretation, they can be used as input for the DFN. If fracture aperture has been measured from conventional cores, they can be used as input.
Seismic data with horizons and faults were available in depth domain so that they can be used as input for fracture interpretation. No seismic interpretation for velocity model building was included.
3D model with all well data, 3D geological model and upscaled simulation model as input for the geomechanics model were used.
3D seismic data in depth domain with horizon and fault interpretation in depth domain were used.
Compile the fracture interpretation from image logs, segregate the open fractures and load in the 3D geologic static model. Study the fracture orientation from rosette diagram map for each stratigraphic formation. Also, prepare stereonets plot of all open fractures for each stratigraphic formation.
Analysis of the above plots, attempt to link fracture sets with the tectonic history (here is the need of the restoration model (Box number 5 in FIG. 1), to understand how many tectonic events) of the field/area. Decide how many sets of fractures to model for each formation segregate the fracture data into sets and relate each set to its tectonic event.
Generate fracture intensity logs for each fracture sets. Carry out similar analysis for the fractures from conventional core description if it is available in oriented cores.
Plot Poisson's ratio and Young's modulus logs with fracture intensity to see existence of geomechanically-controlled layer bound fractures.
Study the interpreted faults and their relation with BHI interpreted fracture corridors. Generate seismic attribute like coherence/semblance in depth domain and study the existence of fracture corridors. If such corridors exist, carry out Petrel Ant-Tracking to interpret fracture corridors. Also, generate curvature attribute to delineate the fracture corridors.

In a preferred embodiment, the method of prediction of hydrocarbon accumulation in a geological region further comprises the steps of:
a. Generating a Discrete Fracture Network;
b. Upscaling the Discrete Fracture Network into the static geomechanics model.
Depending on the data analysis results attempts were made to generate a multi scale fracture model comprising of
   Large scale fracture cutting across formations represented by faults
   Fracture corridors associated with faults picked up from seismic attribute
   DFN for layer bound geomechanically controlled fractures by using facies model, Rigidity modulus model (using Young's Modulus and Poisson's Ratio logs from wells) and fracture intensity logs from wells.
   Small scale diffused fractures best seen from cores.
Assign fracture aperture and permeability to DFN depending on the data availability.
Create three different realization of the DFN to cover the likely uncertainty.
DFN developed were upscaled into the upscaled static model to generate fracture porosity and the fracture permeability tensors (cf. FIG. 16).
The three-fracture model uncertainty realizations were upscaled into the static model described above.
Vertical variations of fracture density in each of the formations (overburden and reservoirs).
Lateral variations of fracture density in each of the overburden and reservoirs.
Combination of vertical and lateral trends of fracture density in each of the overburden and reservoirs.
Fracture orientation, fracture length, fracture aperture and permeability in each of the overburden formations and reservoirs.
Identification of percolating areas (reservoir scale) in each of the overburden formations and reservoirs.
Upscaling of the entire fracture set in each of the overburden and reservoirs.
Interpretation of faults from core, and the alteration caused during faulting resulting in cementation and grain size reduction can be visually very difficult to detect because sedimentary processes in carbonate systems can produce very similar looking structures, grain fabrics, and little or no colour variation. This problem is exacerbated in high deviation wells (laterals) because the intersection relationship of the horizontal well with steep fault and fracture surfaces means that the fractures and faults can appear very similar to drilling induced damage in the core.
These problems were overcome by combining interpretation of core CT scans, which reveal the density changes associated with fracturing, faulting, and high-resolution borehole image data such as image log, which revealed the resistivity changes. The combination of all three factors allows comparison of different physical properties of the rock and not just visual inspection. In addition, by combining the helical CT scan data with the borehole image log, this allows very high-resolution picking and orientation of fracture and fault surfaces directly from the core by utilizing the orientation data in the borehole image log. This combination of data revealed the presence of faults if they do affect the formations sampled.
The structural core description of whole, and/or slabbed core to calibrate image log and using CT scan observations and fully characterize fracture density in the fault zones characterize and perform a detailed investigation for faults using image logs and core data.
Also, characterization of possible cementation within the fault zone and come up with full understanding of the nature of the faults where possible and estimate sense and amount of throw and confirm if any vertical communication between the formations.
This fundamental faulting behavior in overburden and reservoirs and their reactivation and then the impact on the localized hydrocarbon accumulation regions were need to highly precise faulting and fractures identification.
The fault-rock properties from reservoir and overburden units to integrate the geological controls on their permeability.
Initial results suggest that factors such as fault displacement, reservoir Young's modulus, and stress history are all significant in controlling the permeability of fault rock. The project well assesses these parameters dependency.
The algorithms for assessing the impact of fault segments on fluid flow within the studied reservoirs.
Influence of faulting on the high porosity sections relative to the low porosity ones even during shallow burial, can create effect barriers to fluid flow that could compartmentalize reservoirs. So, identifying the permeability reductions in the deformation zones to be measured in faults within high porosity. Therefore, the impact on low porosity zones differed from the high porosity zones and these impacts the fluid flow.
The results show that cementing is the major issues behind the faults to behaving as barriers or not. Therefore, finding the impact of the compaction on reactivation of the fault segments.
The impact of the cataclastic fault segments and cemented breccias on the permeability and on the fractures propagation and if this can potentially compartmentalize the fractured intervals in the deformation zones.
Which fractures sets can evolve, initiate and propagate due production and even injection.
Low displacement faults developed in the overburden formations and reservoirs are often dilational breccias that act as conduits. However, the breccia clasts experience cataclastic deformation with increased throw resulting in the formation of barriers to flow.
The overall trend of low strength reservoirs deforming in a ductile compactive manner and in both low and high porosity sections initially faulting in a dilatant, brittle, manner is similar to the ductile to brittle transition and their impact on the compaction, once happened.
A key aim was to identify key controls on the ductile to brittle transition (i.e. stress, strength, porosity etc.).
The geomechanical properties of the faulted carbonate reservoirs and the correlation between apparent pre-consolidation pressure (i.e. yield point under hydrostatic conditions) and porosity; a key aim was to understand the controls on this relationship.
It is extremely important to critically appraise evidence for fault segments-related compartmentalization in relation to compaction and if the reactivation is a localized phenomenon and hydrodynamics that creating cross-fault differences in fluid contacts, once compaction happened even through such faults may not have a significant impact on production.
The fault rocks can prevent the propagation of open fractures, which may lead to a reduction in communication within reservoirs. What is the impact on compaction, this effect can be predicted by combining core observations with theory on fracture blunting.
Algorithms for assessing the impact of fault segments reactivation on fluid flow within the reservoir and present the patterns measured petrophysical properties from core combining with the BHI, on fault rock samples to generate equations to calculate transmissibility multipliers within the reservoir (cf. FIG. 17).
Assess the dynamic properties (conductivity and aperture) of fracture corridors, which in turn allow the computation of the fracture porosity and permeability tensor (cf. FIG. 18).
Finally, in this stage, assessment of the Impact of Natural Fractures on Reservoir Deformation (cf. FIG. 19), on potential permeability (cf. FIG. 20), fault slip analysis (cf. FIG. 21). Effect of faulting and fractures on slip stress is also identified (cf. FIG. 22).

In a preferred embodiment, the structural model includes information about tectonic stresses in a geological region.

In a preferred embodiment, the geological basin model and the geomechanical model are combined with the structural model to generate the strain maps.

In a preferred embodiment, the structural model is combined with the integrated model.
Using all previous Phases output to integrate the model including 3D geomechanical model was constructed with the mechanical property distribution of Young's modulus, Poison's ratio, friction angle, UCS (Unconfined Compressive strength) and tensile strength within the reservoir overburden formations and also Sideburden.
3-D pre-production stress state was computed including the magnitude and directions of the total vertical, maximum horizontal and minimum horizontal stresses.
3D Grid Construction, and Combination of Separate Reservoir Models, embedment of Overburden, and Underburden and Sideburden was used to build the integrated model.
A fit-for-purpose 3D grid was constructed based on previous models and using the pressure data from the dynamic reservoir models.

In a preferred embodiment, the generation of an integrated model further comprises at least one of the following steps of:
a. 3D Mechanical Properties Population;
b. Mechanical Properties and Stress Model;
c. Pore Pressure Preparation at Selected Time-steps;
d. 3D Pre-production Stress Modelling and Calibration.

Regarding 3D Mechanical Properties Population, this task is mainly done by incorporating 1D Geomechanics models and 3D Seismic Associated Properties and Attributes.
The main inputs for 3D mechanical properties population are 1D Geomechanics models and seismic data (post-stack seismic or pre-stack seismic inversion).
3D mechanical properties population driven by reservoir porosity and upscaled 1D Geomechanics models, and co-krigged with seismic data (acoustic impedance, Vp, Vs etc.). On the premise that pre-stack seismic inversion were not available but post-stack results, such as acoustic impedance and velocity cubes are available for the entire fields, for example, in Abu Dhabi, this option was used to populate the mechanical properties in the 3D geomechanical grid. The key steps include:
Develop correlations between mechanical properties and reservoir porosities. Different correlations were developed for each reservoir, if required based on the 1D Geomechanics models data together with laboratory measured data;
Populate 3D mechanical properties of all reservoir based on the developed correlations;
Populate mechanical properties in the non-reservoir grid-cells using co-kriging method based on upscaled mechanical properties of 1D Geomechanics models and appropriate seismic attributes.
The mechanical property distributions should be consistent with the correlations between mechanical properties and porosity. For example, Young's modulus increases with decreasing porosity. Secondly, make comparison between the mechanical properties of 1D Geomechanics models and the 3D mechanical properties along the trajectories of the 1D Geomechanics models wells.
For a relative representative mechanical property model, the 3D mechanical properties should match those of the 1D Geomechanics models along the well trajectories.
3D mechanical properties driven by seismic inversion. Using the appropriate seismic inversion cube data including the overburden, 3D distribution of rock mechanical properties with spatial heterogeneity within the entire geomechanical model was obtained based on the seismic inversion data, 1D Geomechanics models and laboratory measured core test data. The typical workflow to populate the 3D mechanical properties is with the following key steps:
QC of the seismic inversion cubes were performed with 1D ties. If there is any mismatch, the quality of the seismic inversion data and well data was refined until at least reasonable match was achieved.
Dynamic Young's modulus were calculated from the seismic inversion data.
Based on the mechanical properties correlations, which were developed using 1D Geomechanics models and laboratory measured core test data, mechanical properties were populated in the 3D geomechanical model.
QC 3D mechanical properties.
Comparison between 1D Geomechanics models and 3D mechanical properties extracted along well trajectories were conducted. If there is any significant mismatch, the mechanical properties correlations were refined until at least reasonable match is achieved.
Blind tests were also conducted on few wells selected to further ensure log-derived properties are matching 1D and 3D models.

Mechanical Properties and Stress Model

An ‘equivalent material’ concept was used to simulate the deformation behavior of faulted elements in the geomechanical model. Fault normal and shear stiffness properties, which were estimated based on the Young's modulus of the surrounding intact rock, were used to define the elastic deformation behavior of fault elements. The orientation of the fault surface at each grid cell provides a specific direction of fault shear and dilation. Using the “Discontinuity modelling”, the cells that intersected by the fault surfaces were assigned an “equivalent” stiffness properties, with a view to capturing both their deformation and failure behavior. Mathematically, the equivalent properties are calculated by combining properties of the intact rock and faults (joints) by using a constitutive theory. It is assumed that there is a relative movement in the cells along the fault plane due to the difference in mechanical properties from the surrounding cells.
Fault grid-cells are treated as fault elements with stiffness characterized by a normal stiffness and shear stiffness. The faults are modelled as embedded fault planes within intersected grid cells. The elastic deformation behavior of the simulated fault elements is determined with both elastic properties of the intact rock and the fault plane.
In the direction normal to the fault plane, both fault plane and intact rock are under the same stress. Therefore, the normal strain of the fault element can be expressed as:

$$\frac{σ}{{E}_{equiv}} = \frac{σ}{{E}_{intact}} + \frac{σ}{{E}_{fault}}$$

where σ is the normal stress acting on the fault element normal to the surface of the fault plane, E_{equiv} is the equivalent Young's Modulus, E_{intact} is the Young's Modulus of the intact rock, and E_{fault} is the Young's Modulus of the fault. E_{fault} is related to the spacing (S) of fault within an element and the normal stiffness of the fault plane (Kₙ).

Then it can be derived:

$$\frac{σ}{{E}_{equiv}} = \frac{σ}{{E}_{intact}} + \frac{σ}{{K}_{n} S}$$

Assuming E_{equiv}=E_{intact}*a (a is a sensitivity analysis parameter (range from 0 to 1), then Kₙ can be calculated by:

$${K}_{n} = \frac{a}{( 1 - a ) S} {E}_{intact}$$

Kₛ is the shear stiffness of a fault surface to define the elastic shear deformation of the fault element subjecting to a shear stress. The shear stiffness of a fault surface is related to the lithology of the intact rock, the fault shear displacement experienced and the fault gouge properties, if any, etc. The typical value of fault shear stiffness is assumed to be 40%-60% of the normal stiffness Kₙ value. The cohesion of the fault has generally a very low value or zero to reflect the typical mechanical behavior of a discontinuity, such as a fault.

Pore Pressure Preparation at Selected Time-Steps
For the reservoirs, the production scenario in all reservoir models of different reservoirs started from the earliest time of 1960 (Thamama B), to latest time of 2017 (HB1 and Thamama A). The end of production times are 2023 (Thamama G), 2051 (Thamama C), 2058 (Thamama H), 2117 (Thamama A).
To better understand the rock deformation and time of potential geomechanical-related issues, a time-step scheme is required to determine the optimum timing to incorporate the effects of depletion in the coupled simulations.
The time-steps are the points in time at which stress analyses were performed, accounting for pressure effects and to provide suitable points in time for verification of geomechanical-related events.
To determine the optimum timing of these time-steps, a value of field average pressure was plotted against production time to determine the periods of greatest pressure change.
The detailed procedure on selection of time-steps can be summarized as:
   For all reservoirs (per field), an integrated analysis was conducted on the field average pressure of all the reservoirs.
   Combined dates for time-steps by considering all the dates from one-way and two-way coupling.

After the pressure extraction of the selected time-steps, the pressure was exported from Eclipse models and assigned to corresponding reservoir grids constructed previously at the respective time-steps:
For all reservoirs (per field), the pressure of the selected time-steps was mapped to the geomechanical model for each of reservoir grids;
For the non-reservoir grid, the pressure gradient was remaining constant.

3D Pre-Production Stress Modelling and Calibration
3D pre-production stress modelling and calibration were performed for the embedded 3D geomechanical model.
The embedded model were exported to the finite element geomechanical simulator. Pore pressure from the reservoir model prior to production were adopted as initial pressure distribution within the reservoirs.
As mentioned above, the pore pressure distribution in non-reservoirs and surrounding formations were based on the pore pressure data of the 1D Geomechanics models.
The 3D density cube within the embedded 3D geomechanical model were used to compute the total vertical stress within the 3D model.
Regional stress estimated based on the in-situ stress profiles of the 1D Geomechanics models and consistent with the regional geological setting were applied to the model boundaries.
Stress equilibration of the model were subsequently performed to achieve the initial static stress equilibrium prior to production.
As mechanical properties are unlikely to be homogeneous and uniform within the formations, the equilibrium stress state reflect these variations in mechanical properties, including the impact of the presence of faults.
A series of parametric steps were conducted to refine the predicted initial pre-production stress until:
   (a) Computed stress state in the 3D geomechanical model is consistent with the stresses along the 1D Geomechanics models.
   (b) Computed mud weight windows of the available and selected offset wells, which found consistent between 3D geomechanical model and 1D Geomechanics models.
Once a consistent match of in-situ stress profiles and mud weights between 3D geomechanical model and 1D Geomechanics models is achieved, the computed 3D initial stress state is representative of the in-situ stress state, not only along the existing well trajectories, but also between the wells.
This unique 3D stress generation and calibration technique proposed by this invention considers equilibrium of the entire 3D model and can predict stress rotations near faults (cf. FIG. 23), and other discontinuities, such as fractures (cf. FIG. 24), bedding planes, etc.
Mohr-Coulomb model and Cap Model were used to identify shear/tension and pore collapse failure locations in the fields. With the coupled geomechanical numerical simulations, the failure time and location can be identified based on failure index (plastic strain) predicted in the fields.
The stability of fault is controlled by the respective stress state, fault attributes (size, dip angle and dip direction) and fault strength parameters (cf. FIGS. 23 and 24). The slip potential of all faults simulated in the 3D geomechanical model were computed at present-day and future time-steps. The slip potential is indicated with a value between zero and one. A low slip potential indicates a low risk for fault reactivation. When the slip potential of a fault is close to unity, a relatively small change in stress state is likely to reactivate the fault. When the slip potential is equal to unity, the fault is at a critical stress condition.

In a preferred embodiment, the hydrocarbon accumulations are predicted from the outputs received from the before noted steps.

Hydrocarbon Accumulations

Hydrocarbon Accumulations can be obtained based on the simulation results of the above steps:
The 3D poroelastic-brittle FE (Finite Element) model of the Abu Dhabi region, for example, produces a wide variety of output data such as vectors of the principal stresses whose magnitude has been normalized by the overburden stress (cf. FIG. 25).
Next, the mean and shear stress as well as the full Cartesian strain and stress tensors are output to analysis (cf. FIG. 26).
The present-day stress state and reservoir deformation will continuously change during future production. To assess the impact of stress changes on reservoir deformation in future production, coupled reservoir simulations were carried out from present-day stress condition to life of the fields.
The reservoir pressure changes in the reservoir models at each of the predefined time-steps were used to compute the changes in stress of the reservoirs and surrounding formations (cf. FIG. 27).
Using the computed strains and comparing these strain maps with the fields and hydrocarbon accumulations, found they match.
Therefore, the invented workflow is a great workflow to predict the hydrocarbon accumulations.
It is found that, the hydrocarbon accumulations are following some trends, and therefore giving the name of hydrocarbon belts.

In a preferred embodiment, the step of generation of strain maps comprises the following steps of:
a. Modeling of overburden stress of the geological region;
b. Modeling of effective stress of the geological region;
c. Modeling of pore stress of the geological region.

In a preferred embodiment, the strain maps indicate regions of high and low strain. In a preferred embodiment, the prediction of hydrocarbon accumulation includes a delineation of areas where hydrocarbon is trapped, and a prediction of migration pathways for hydrocarbon. Further, the above noted problems can at least partially be solved by a map indicating hydrocarbon accumulation, wherein the map is gained by a method of prediction according to one of the above noted features. The term “map” is herein to be understood in a broad sense, namely as a suitable representation of the information provided perceivable by a user, which includes but is not limited to one or more graphical 2D and 3D representations. Hence, the visualized hydrocarbon accumulation areas can enable and/or facilitate exploration and Field Development Plan.

Further, the above noted problems can at least partially be solved by a computer program product comprising instructions which, when the program is executed by a computer, cause the computer to carry out the steps of the method noted above.

Further, the above noted problems can at least partially be solved by a computer-readable storage medium comprising instructions which, when executed by a computer, cause the computer to carry out the steps of the method noted above.

Further, the above noted problems can at least partially be solved by a data processing system comprising means for carrying out the steps of the method noted above.

### 4. SHORT DESCRIPTION OF THE DRAWINGS

In the following, preferred embodiments of the invention are disclosed by reference to the accompanying figures, in which:

FIG. 1 shows a workflow for creating strain maps, hydrocarbon accumulations and belts according to the present invention;

FIGS. 2A-C show a geologic model, where any layer deposited are undergoing two processes; namely compaction and tectonics; according to the present invention;

FIGS. 3A-C show porosity modeling according to the present invention;

FIGS. 4A-D show the application of the porosity model on one formation according to the present invention;

FIG. 5 shows a 3-D porosity model according to the present invention;

FIGS. 6A-B show calibrating the pressure model according to the present invention;

FIGS. 7A-D show a pressure model example in one formation according to the present invention;

FIG. 8 shows a 3-D pressure model according to the present invention;

FIGS. 9A-D show overpressure results in one formation according to the present invention;

FIGS. 10A-B show overpressure and permeability maps according to the present invention;

FIG. 11 shows the density dependency on angle range of the seismic to estimates layer properties;

FIGS. 12A-C show mechanical properties based on porosity correlations derived from core results in the workflow for 1D Geomechanics models according to the present invention;

FIG. 13 shows a 1D Geomechanics model example according to the present invention;

FIGS. 14A-E show the mapping of the mechanical parameters across Abu Dhabi according to the present invention;

FIG. 15 shows a borehole image log example according to the present invention;

FIGS. 16A-C show Extraction of Seismic Discontinuity Plans (SDP): Analysis and Input for DFN according to the present invention;

FIGS. 17A-B show faults corridor in one field (FIG. 17A) and the reactivation of some fault segments within the corridor (FIG. 17B) according to the present invention;

FIGS. 18A-E show dynamic properties (conductivity and aperture) of fracture corridors, leading to fracture porosity and permeability tensor according to the present invention;

FIGS. 19A-F show the impact of Natural Fractures on Reservoir Deformation in one formation according to the present invention;

FIGS. 20A-F show the impact of Natural Fractures on potential permeability in one reservoir section according to the present invention;

FIGS. 21A-B show the impact of Natural Fractures on fault slip analysis according to the present invention;

FIGS. 22A-F show fault Effect on Stress Direction according to the present invention;

FIG. 23 shows a map of shear stresses relative to tectonic stresses according to the present invention;

FIG. 24 shows stress rotations near faults according to the present invention;

FIG. 25 shows a finite element model of the Abu Dhabi region normalized by the overburden stress according to the present invention;

FIG. 26 shows a map of mean and shear stress according to the present invention;

FIG. 27 shows a map of hydrocarbon accumulations according to the present invention.

### 5. DETAILED DESCRIPTION OF PREFERRED EMBODIMENTS

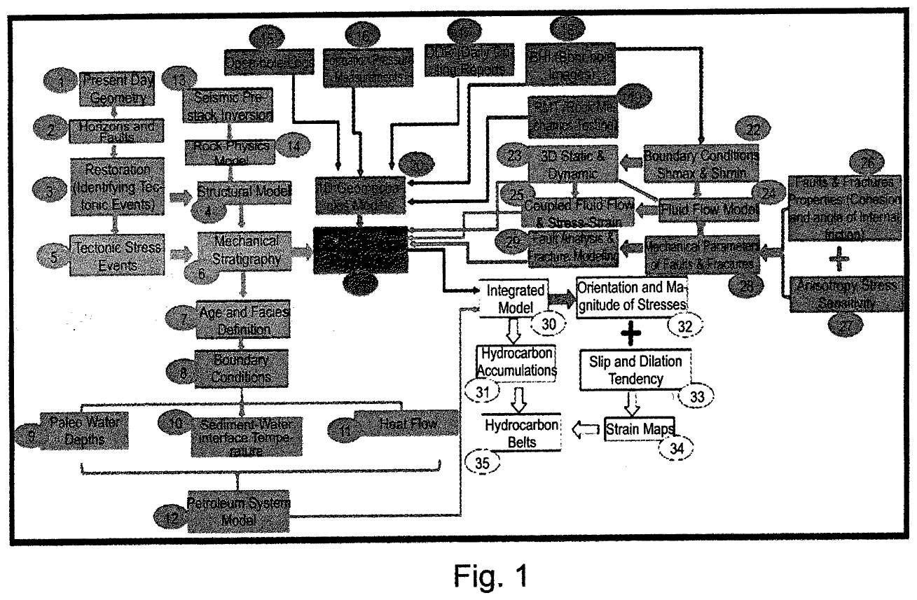

FIG. 1 shows a workflow for creating strain maps, hydrocarbon accumulations and belts according to the present invention. Herein, FIG. 1 provides an overview of the steps that can be employed to generate a respective model. In particular, FIG. 1 shows that Horizons (surfaces) and faults were interpreted from seismic data and derived from isopach maps (cf. blue boxes with numbers 1 to 12). Further, FIG. 1 shows the steps relating to the step of seismic inversion (cf. orange boxes with numbers 13 and 14). Further, FIG. 1 shows the steps of generating a 1D geomechanical model (cf. purple boxes with numbers 15 to 20) and 3D shown in dark blue box with number 21. Further, FIG. 1 shows the steps of modeling of the 3D static and dynamic (cf. green boxes with numbers 22 to 25 and red boxes with numbers 26 to 29). Further, FIG. 1 shows the steps relating to the generation of an integrated model up to strain maps; hydrocarbon accumulations and hydrocarbon belts (cf. yellow boxes with numbers 30 to 35).

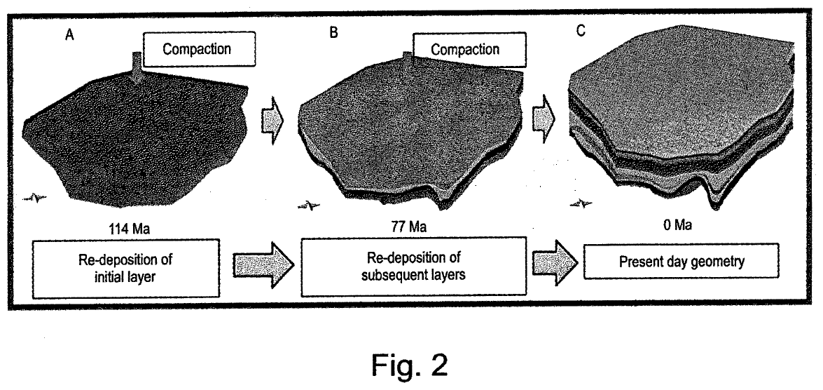

FIGS. 2A to C show a geologic model, where any layer deposited is undergoing two processes; namely compaction and tectonics according to the present invention. This relates to steps No. 1-12 in FIG. 1. FIG. 2A shows backstripping of the model to the oldest formation. Simulation process started with decompaction of the formation layers and then re-deposition of each of the older formation until the present day (FIGS. 2B and 2C). At each of the geological time steps, parameters such as porosity and pore pressure were calculated. These calculations were controlled by lithology parameters for each of the layers. The simulation results were analyzed and compared with present well data such as porosity and formation pore pressure. Calibration processes were required when the calculated output results were not consistent with the well data. The initial model parameters needed to be modified and the modifications were done in the model-building step. Once the modifications were finalized, the model needed to be re-simulated. The output results of the modified model should honor the well data. Herein, lithology parameters were modified to get good matches of porosity and pore pressure output results to the well data.

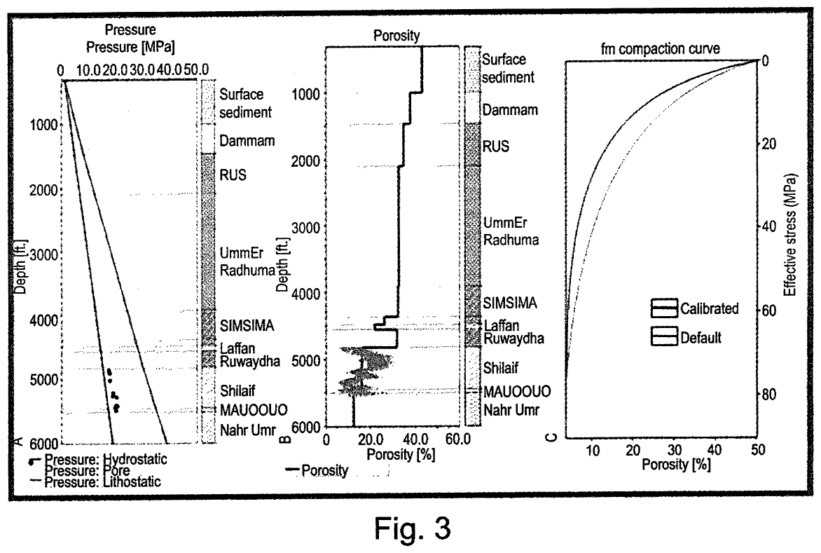

FIGS. 3A-C show porosity modeling according to the present invention. This relates to steps No. 4-10 in FIG. 1. FIGS. 3A and 3B show the modeled porosity and the modeled pressure for various depths. The porosity-effective stress relationship was used to calibrate compaction curves for lithological layers. FIG. 3C shows the calibrated compaction curve versus the default compaction curve.

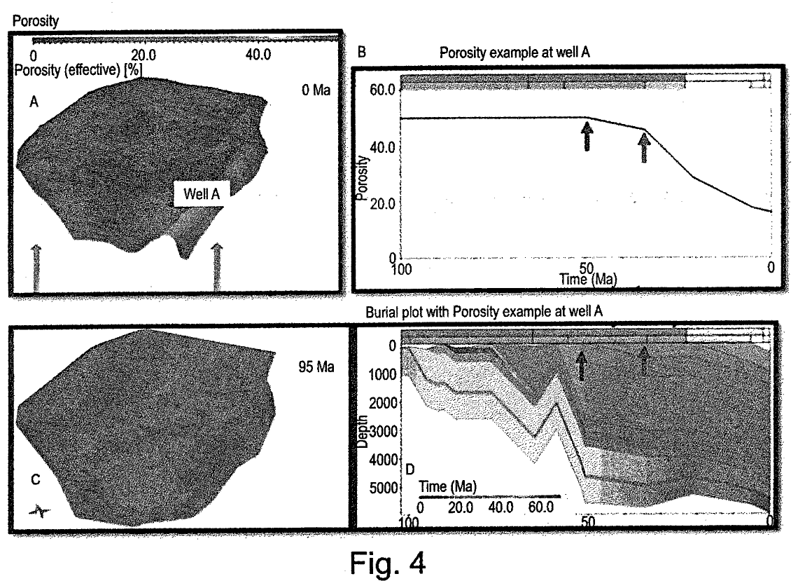

FIGS. 4A to D show the application of the porosity model on one formation according to the present invention. This relates to steps No. 7-12 in FIG. 1. The simulated porosity model is able to predict porosity for each of the formation layers (cf. FIG. 4) and at each geological time steps. The porosity was calculated based on compaction curves and these compaction curves were unique to the formation. While this approach captures the spatial variation of porosity throughout the formation layers. The porosity of a given geological area is shown for the time points of today in FIG. 4A and 95 million years ago in FIG. 4C. FIG. 4B shows to porosity at the position of the well denoted with “A” (cf. FIG. 4A) at different times from around 100 million years ago to the present. As can be seen from the figure, the porosity decreases in time. FIG. 4D shows a burial plot of the different geological layers at different depths with a porosity overlay at the position of Well “A” (cf. FIG. 4A) at different times from 95 million years ago to the present.

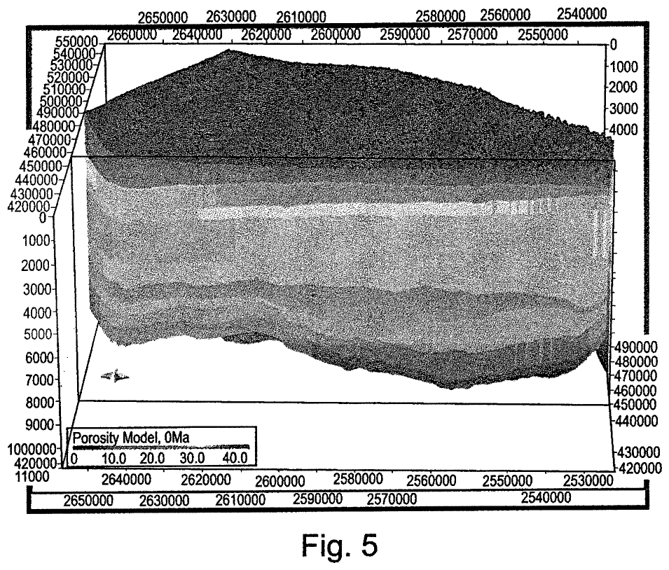

FIG. 5 shows a 3-D porosity model according to the present invention. This relates to steps No. 10-12 in FIG. 1. Based on the results, as shown in FIG. 4, porosity distribution in rock sequence ranges were predicted and calibrated using real data from the lab testing at present day.

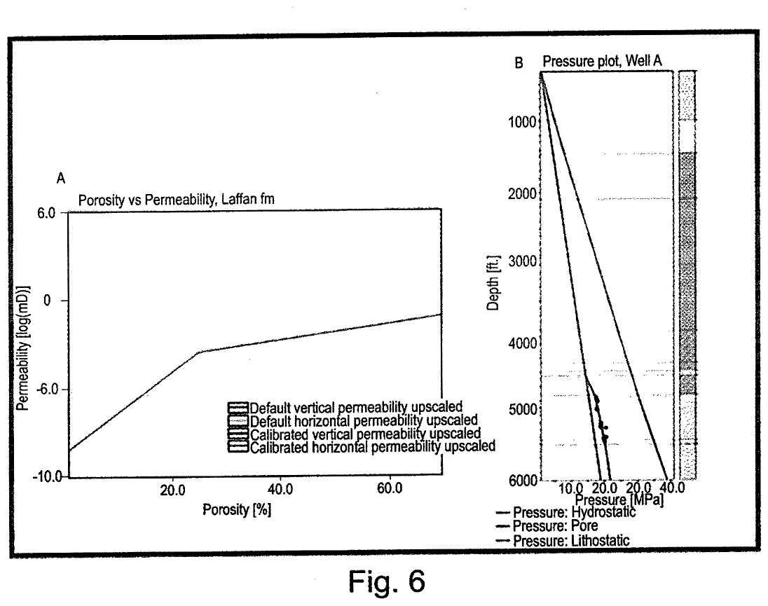

FIGS. 6A and B shows calibrating the pressure model according to the present invention. This relates to steps No. 1-12 in FIG. 1. FIG. 6A shows example of this where three pairs of log permeability-porosity are plotted for the Laffan layer as an example. By decreasing, the permeability values at its corresponding porosity, fluid flow is restricted and pore pressure of the formation and below will increase. FIG. 6B shows a pressure simulation of the geological layers at the position of Well A at different depths for the hydrostatic pressure, the lithostatic pressure and the pore pressure.

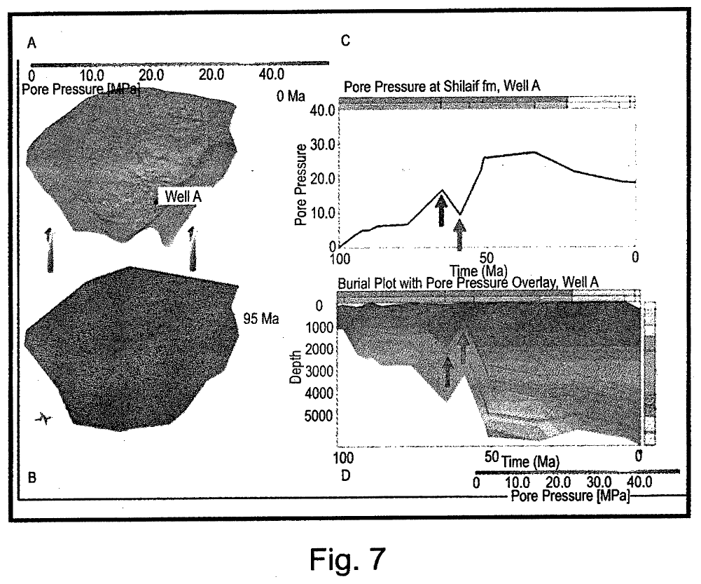

FIGS. 7A to D show a pressure model example in one formation according to the present invention. This relates to steps No. 1-12 in FIG. 1. Formation pore pressure showed good spatial pressure distribution and the evolution of pore pressure honors geological events that were captured during structural model building. The pore pressure of a given geological area is shown in the 3D model in FIG. 7A. FIG. 7B shows the created pressure at one layer (horizon) created from the model in 7A. FIG. 7C shows the pressure changes with time created from the 3D model at one well (A) location. FIG. 7D shows a burial plot of the different geological layers at different depths with pore pressure overlay at the position of Well A (cf. FIG. 7A).

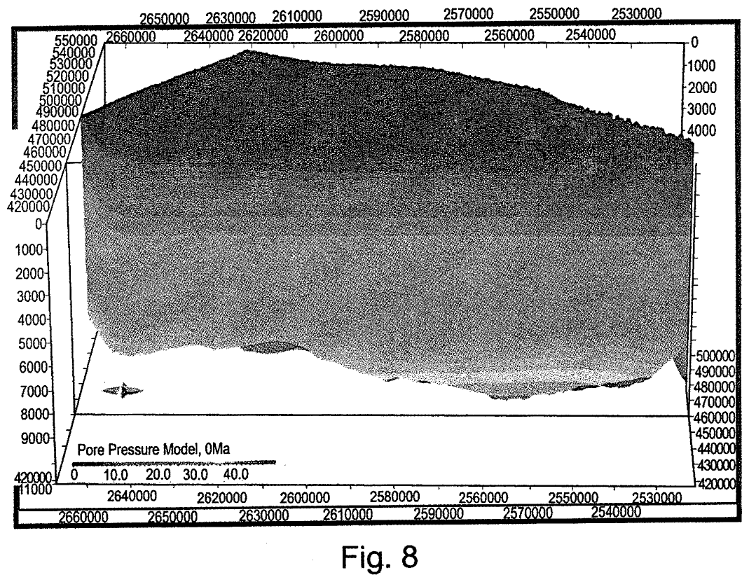

FIG. 8 shows a 3-D pressure model according to the present invention. This relates to steps No. 1-12 in FIG. 1. Herein, the resulting values, as shown in FIG. 7 were simulated and predicted for each formation layer.

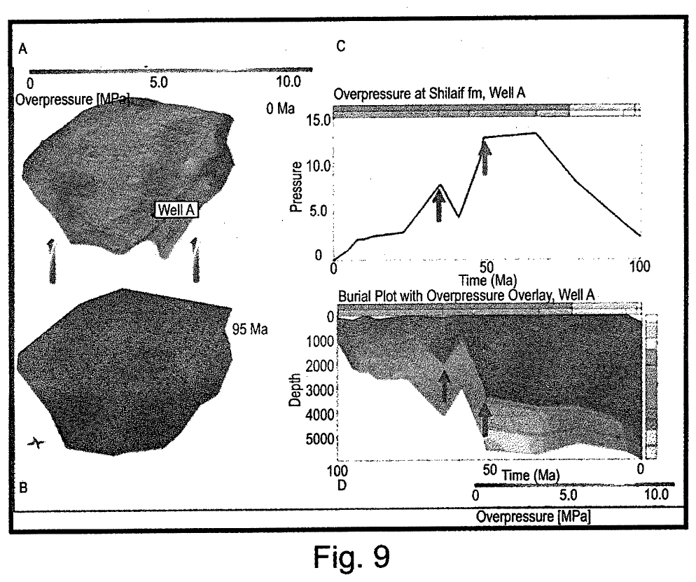

FIGS. 9A to D show overpressure results in one formation according to the present invention. This relates to steps No. 1-12 in FIG. 1. The overpressure of a given geological area is shown for the time points of today in FIG. 9A and one layer as an example (95 million years ago) in FIG. 9B. FIG. 9C shows overpressure of the layer at the position of Well A (cf. FIG. 9A) at different times from 100 million years ago to the present. FIG. 9D shows a burial plot of the different geological layers at different depths with overpressure overlay at the position of Well A (cf. FIG. 9A) at different times from 100 million years ago to the present. Modeling overpressure is crucial and as shown in FIG. 9, reveals areas where overpressure is observed from simulation results. This shows clearly pressure increases with depth. Formations pressure network is very important to predict overpressure in the model. The connectivity of low permeable formation has an effect on the pressure system of the formations adjacent to it. The nature of formation allows pressure to be transferred via the movement of fluid within the formation such as connate water from a higher pressure zone to a lower pressure zone.

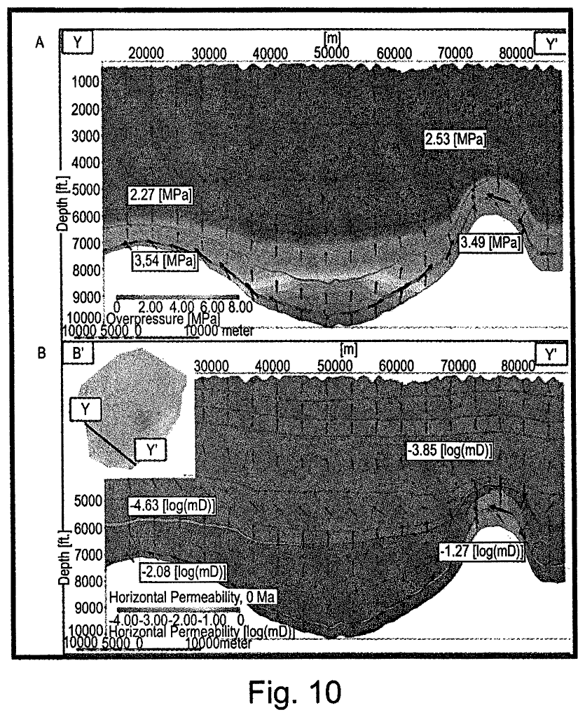

FIGS. 10A and B show overpressure and permeability maps according to the present invention. This relates to steps No. 1-12 in FIG. 1. The graphs are taken along a line Y to Y′ of the area depicted in FIGS. 4, 7 and 9, as show in FIG. 10B′. Herein, FIG. 10A shows the overpressure along the line Y to Y′ for different depths and respective layers and FIG. 10B shows the horizontal permeability along the line Y to Y′ for different depths and respective layers. The respective arrows show the corresponding fluid flow. As noted before, the nature of formation allows pressure to be transferred via the movement of fluid within the formation such as connate water from a higher pressure zone to a lower pressure zone. This case can be seen in the overpressure model of one layer as an example formation shown in FIGS. 10A and B. The overpressure of the deeper section of the formation is lower than the overpressure of the shallower formation.

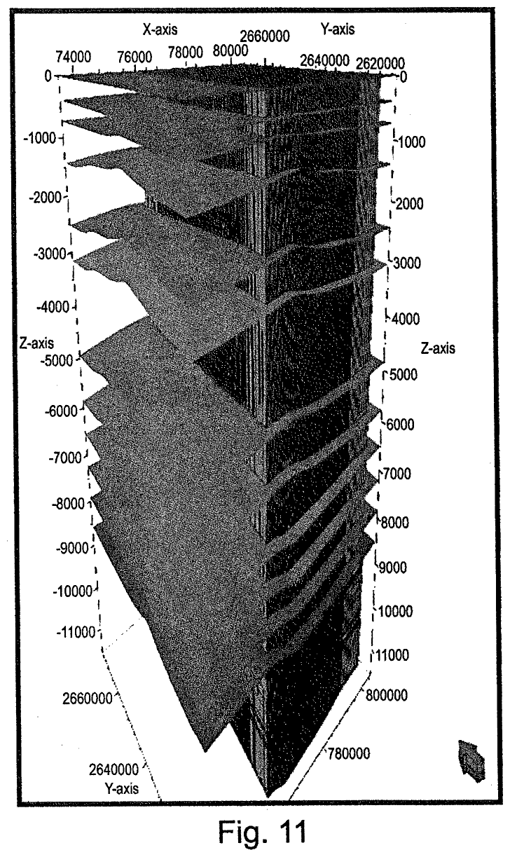

FIG. 11 shows the density dependency on angle range of the seismic to estimated layer properties. This relates to steps No. 13-14 in FIG. 1. The elastic parameters are created by following a workflow dependent on pre-stack seismic inversion.

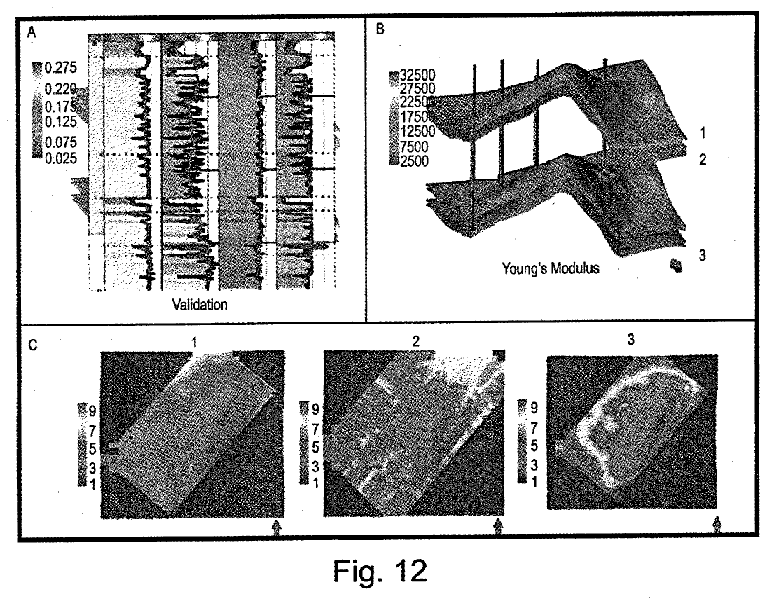

FIGS. 12A-C show mechanical properties based on porosity correlations derived from core logs results in the workflow for 1D Geomechanics models according to the present invention. The results of the 1D Geomechanics model are calibrated using lab measurements on cores. This relates to steps No. 13-14 and 15-21 in FIG. 1. Herein, FIG. 12A shows the created parameters from the prestack inversion, calibrated with the 1D Geomechanics models results (15-21). FIG. 12B shows the Young's modulus in some layers variations. FIG. 12C 1, 2 and 3 show the mechanical parameters at one horizon as an example.

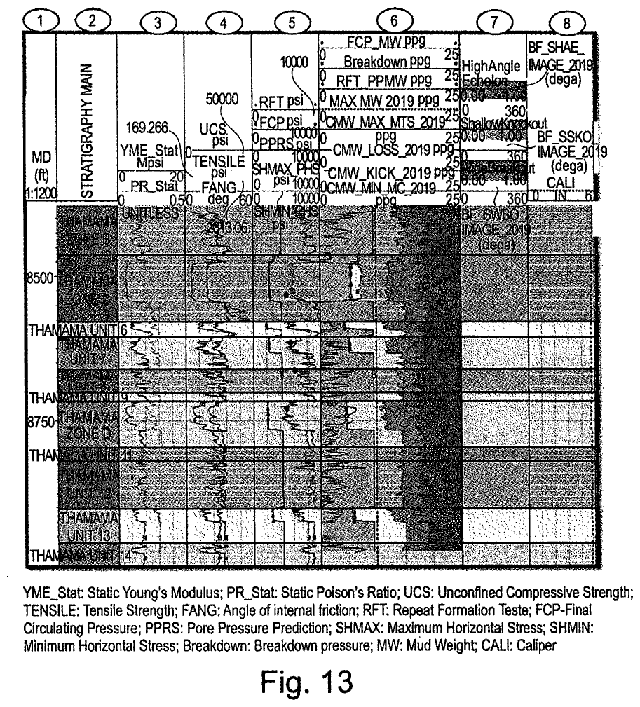

FIG. 13 shows a 1D Geomechanics model example according to the present invention. This relates to steps No. 15-20 in FIG. 1. Herein, the model was exemplarily constructed for Abu Dhabi fields. The first track (Nr. 1) shows the depth. The second track (Nr. 2) shows the chosen formations presented as example. The third track (Nr. 3) shows the Young's modulus (YME) and Poisson's ratio (PR). The fourth track (Nr. 4) shows the unconfined compressive strengths (UCS), tensile strengths (TSTR) and angle of internal friction (FANG). The fifth track (Nr. 5) shows the stresses, the black curve is the vertical stress (sv), SHmax (maximum horizontal stress), SHmin (minimum horizontal stress). The sixth track (Nr. 6) shows the results of wellbore stability showing the safe mud window and fracture gradient. The seventh track (Nr. 7) shows the instability intervals and the eighth track (Nr. 8) shows the caliper.

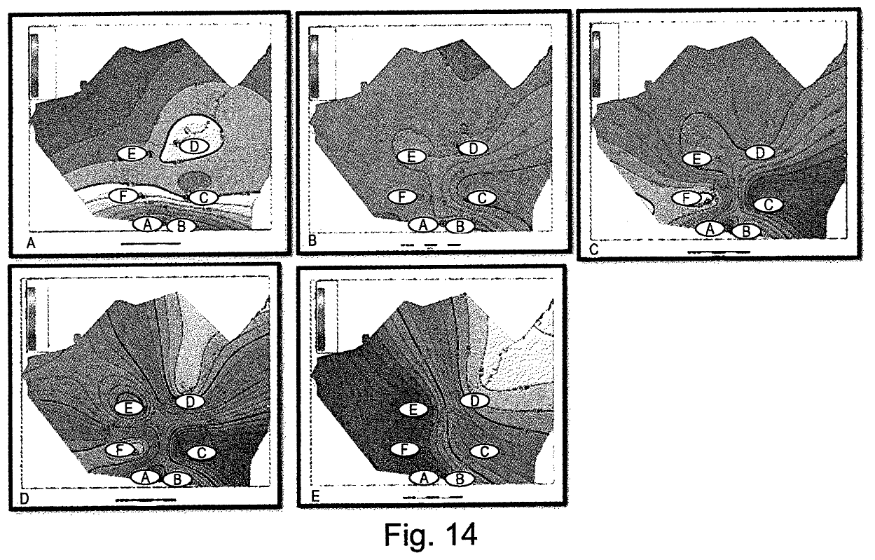

FIGS. 14A to E show the mapping of the mechanical parameters across Abu Dhabi according to the present invention. This relates to steps No. 13-21 in FIG. 1. Herein, rock elastic and strength property parameters are constructed for the overburden and reservoir sections using available log and core test data for calibration. The most appropriate correlations are used to establish log-derived elastic and rock strength property profiles. In particular FIG. 14A shows Young's Modulus; FIG. 14B shows Poisson's Ratio; FIG. 14C shows unconfined compressive strengths; FIG. 14D shows tensile strengths; FIG. 14E shows minimum horizontal stress. The oval indications A, B, C, D, E, and F in each figure show the selected wells for validating the mechanical parameters.

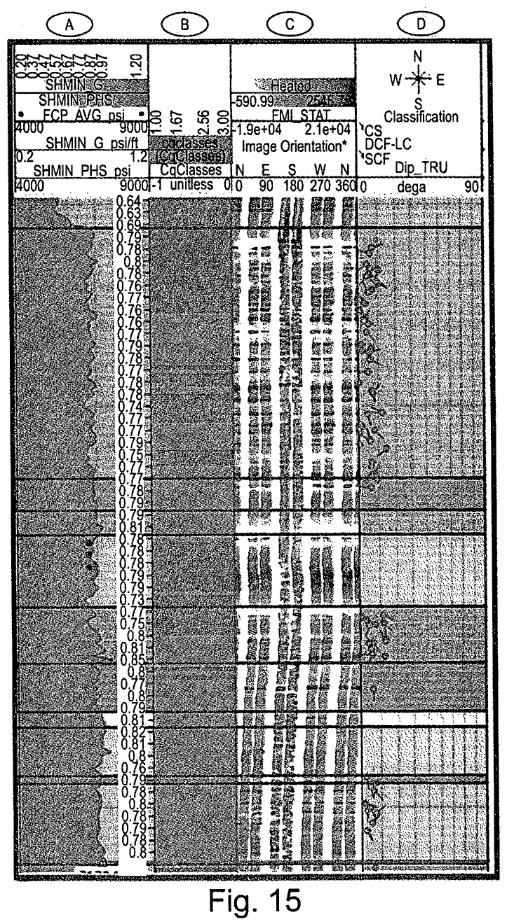

FIG. 15 shows a borehole image log example according to the present invention. This relates to steps No. 18 and 26-29 in FIG. 1. The first track (A) shows the minimum horizontal stresses (SHMIN) depending on breakouts; direct measurements through tests and; the second track (B) shows conductivity; the third track (C) shows the static image and the fourth track (D) shows the azimuth and dip of the CS: conductive seams; DCF=LC: discontinuous conductive fractures and SCF: subsidiary conductive fractures.

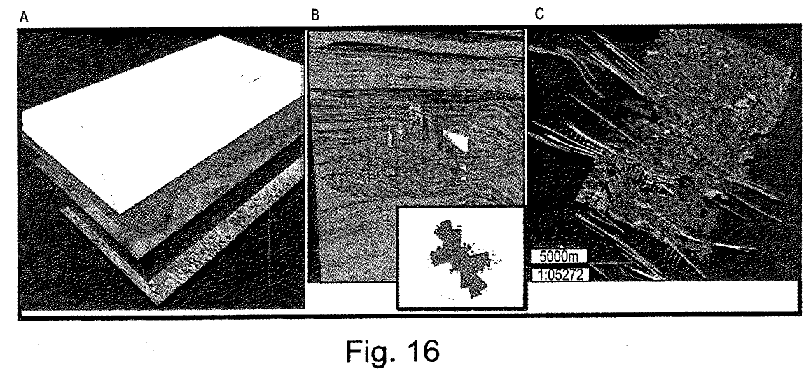

FIGS. 16A to C show fractures and microfaults modeling: Analysis and Input for DFN according to the present invention. This relates to steps No. 26-29 in FIG. 1. In particular, FIG. 16A shows Fracture Detection: Structural Decomposition (Seismic Volume Attributes). FIG. 16B shows the horizons, faults interpretation, and natural fractures around wells from BHI. FIG. 16C shows Extraction of SDP (Seismic Discontinuity Plans): Analysis and Input for DFN.

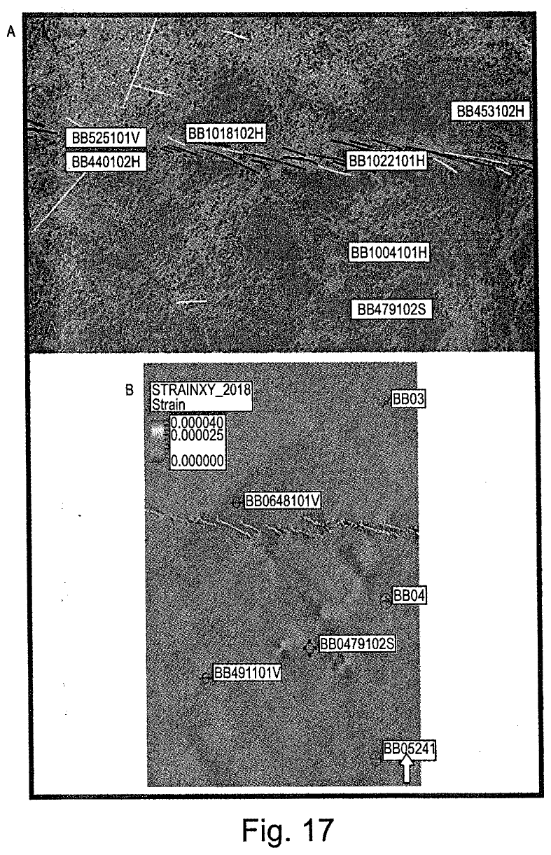

FIG. 17A shows faults corridor in one onshore field of Abu Dhabi; FIG. 17B shows the reactivation of some fault segments within the corridor according to the present invention. This relates to steps No. 22-29 in FIG. 1.

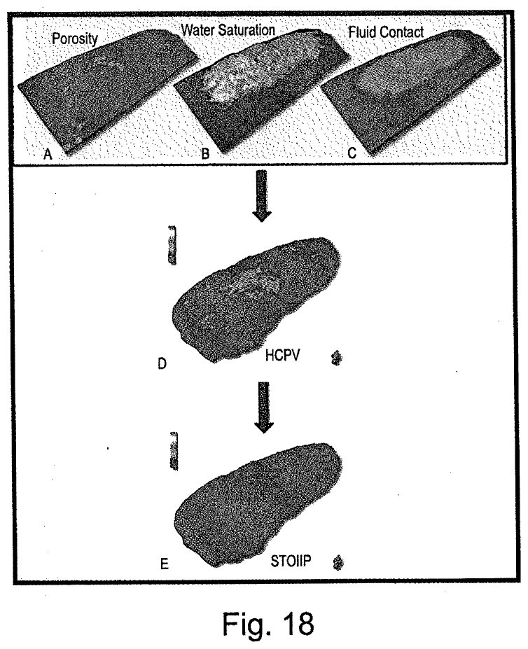

FIGS. 18A to E show dynamic properties (conductivity and aperture) of fracture corridors, leading to fracture porosity and permeability tensor according to the present invention. This relates to steps No. 22-29 in FIG. 1. In particular, in FIG. 18A a porosity model created from steps 1-12 is calibrated and validated using fracture aperture and connectivity from BHI. FIG. 18B shows petrophysical model with saturation; FIG. 18C shows fluids contacts as the common contact in one reservoir. FIG. 18D shows the formula results used in volume calculations HCV=Pore volume×So and FIG. 18E shows STOIIP=HCVo/Bg+(HCVg/Bg)×Rv. Abbreviations: STOIIP=stock-tank oil initially in place, the volume of oil in a reservoir prior to production; HCP=HC (hydrocarbon) initially in place of oil. Solution gas, free gas or condensate at standard surface conditions. GRV=Gross volume; NRF=Net Rock volume; NPV=Net pore volume; HCPV=Hydrocarbon pore volume; So=oil saturation . . . etc.

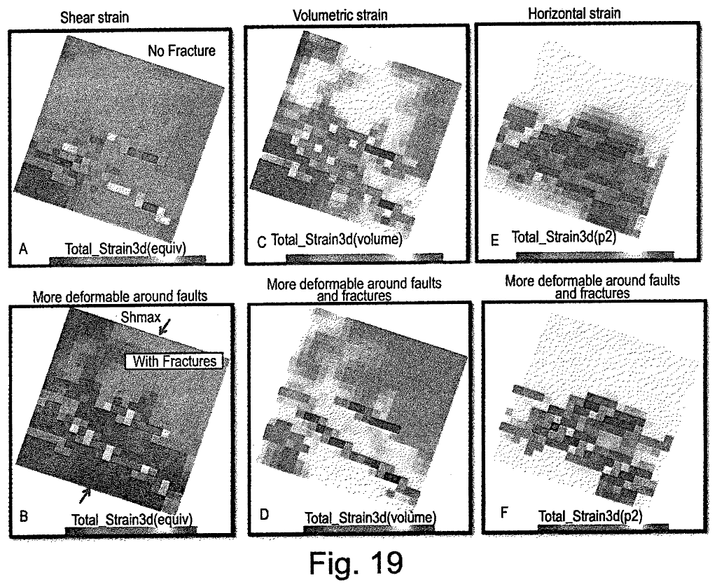

FIGS. 19A to F shows impact of Natural Fractures on Reservoir Deformation in one formation according to the present invention. This relates to steps No. 22-29 in FIG. 1. In particular FIG. 19A shows the shear strain with no fractures. FIG. 19B shows the total strain (deformation) with the presence of fractures. FIG. 19C shows volumetric strain that is not only the reservoir but due overburden. FIG. 19D shows the deformation is increased around the faults. FIG. 19E shows the horizontal strain and FIG. 19F shows the deformation around faults and fractures on the horizontal.

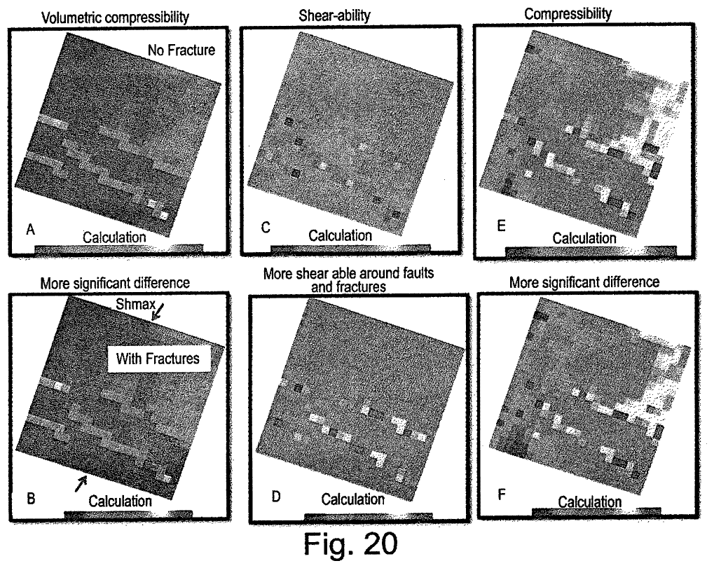

FIGS. 20A to F show the impact of Natural Fractures on potential permeability in one reservoir section according to the present invention. This relates to steps No. 22-29 in FIG. 1. In particular, FIG. 20A shows the volumetric compressibility in case of no fractures and FIG. 20B with presence of fractures. FIG. 20C shows the shear ability and 20D with shear around faults and fractures. FIG. 20E shows compressibility on one layer and 20F the more impact with the inclusion of fractures and faults.

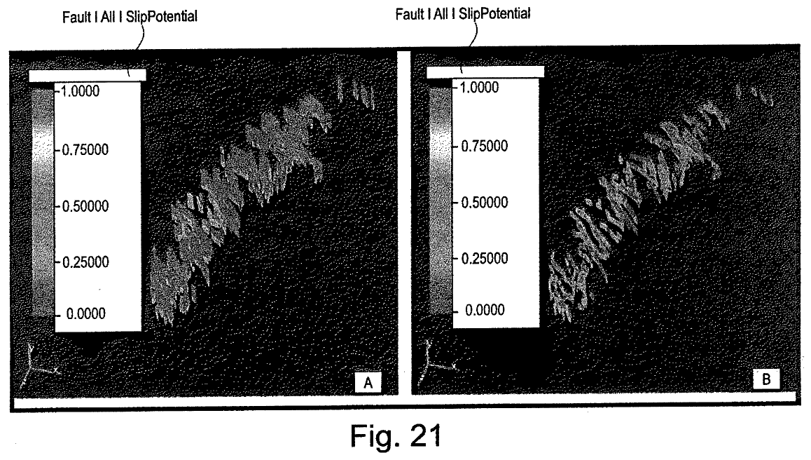

FIGS. 21A and B show the fault slip potential analysis according to the present invention. This relates to steps No. 26-29 in FIG. 1. In particular, FIG. 21A shows the slip along faults and FIG. 21B shows the inclusion of those fractures with potential slip.

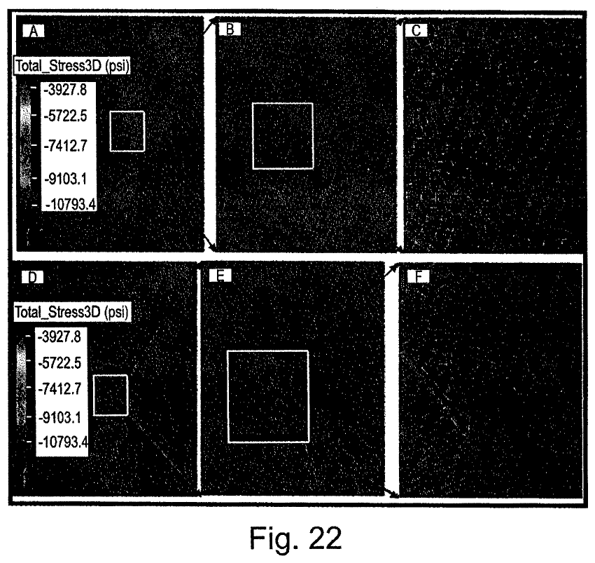

FIGS. 22A to F show the fault Effect on Stress Direction according to the present invention. This relates to steps No. 26-29 in FIG. 1. In particular FIGS. 22A, B and C show the stress analysis around faults showing total stress and clear of the stress deviation. FIGS. 22D, E and F show the corresponding stress variation showing maximum and minimum horizontal stresses.

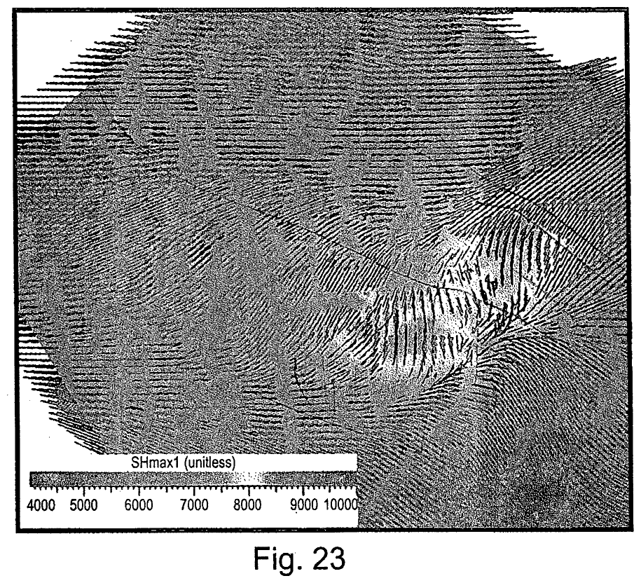

FIG. 23 shows a map of shear stresses relative to tectonic stresses according to the present invention. This relates to steps No. 26-29 in FIG. 1. It clearly shows the rotation of the stresses around the master faults.

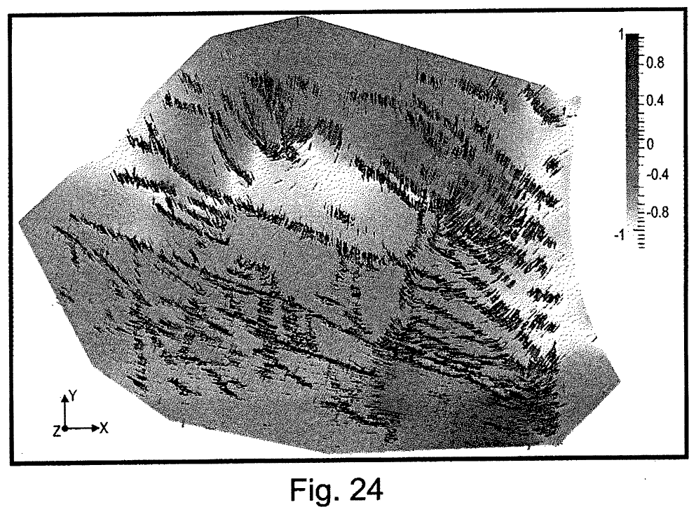

FIG. 24 shows stress rotations near faults according to the present invention. This relates to steps No. 26-29 in FIG. 1. This shows the stress rotation around some faults while others not.

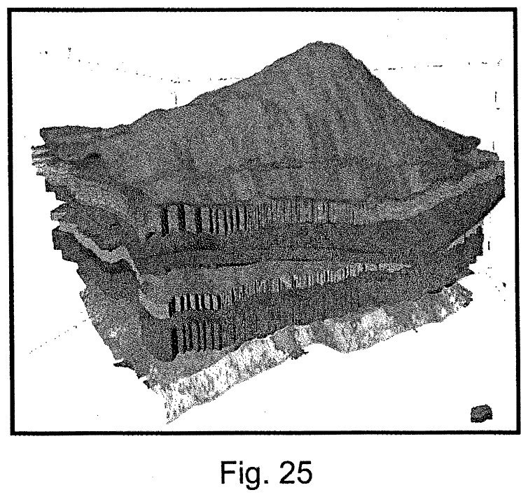

FIG. 25 shows a finite element model of the Abu Dhabi region normalized by the overburden stress according to the present invention. This model shows all the layers and horizons from surface to reservoirs level. The model integrated all the previous models in one. This relates to steps No. 21 and in FIG. 1.

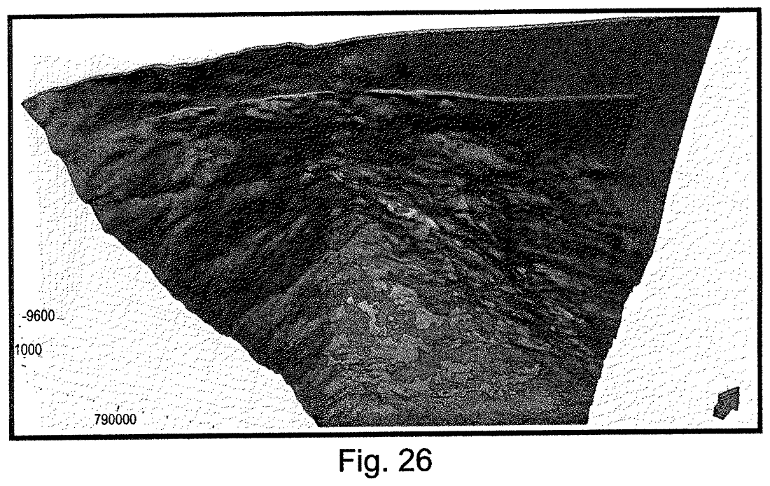

FIG. 26 shows a map of mean and shear stress according to the present invention. This relates to step No. 32 in FIG. 1. This shows the shear stresses in one layer as an example.

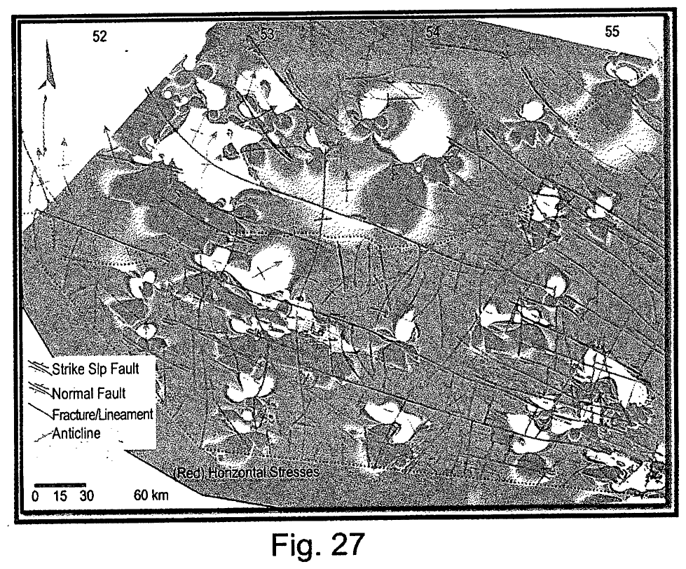

FIG. 27 shows a map of hydrocarbon accumulations according to the present invention. This relates to steps No. 31-35 in FIG. 1. This map shows the hydrocarbon accumulations and those trending in one direction forming hydrocarbon belts. The hydrocarbon accumulations show a relation with the low strain areas. Some of those are showing a strict trend, which means they are tectonically related and therefore named hydrocarbon belts.

1. Method of prediction of hydrocarbon accumulation in a geological region comprising the following steps of:
a. Generation of a geological basin model;
b. Generation of a geomechanical model;
c. Generation of an integrated model;
d. Generation of a strain map based on the information obtained in steps a to c;
e. Prediction of hydrocarbon accumulation from the strain maps.

2. Method of prediction of hydrocarbon accumulation in a geological region according to claim 1, wherein the geological basin model further comprises at least one of the following steps of:
a. Determination of Horizons and faults;
b. Restoration and backstripping to identify the tectonic events;
c. Modeling porosity;
d. Modeling pressure;
e. Modeling Porosity-permeability relationship.

3. Method of prediction of hydrocarbon accumulation in a geological region according to claim 2, wherein the step of modeling pressure further comprises at least one of the following steps of:
a. Calibration of the pore pressure model;
b. Application of the pore pressure model to the geological region.

4. Method of prediction of hydrocarbon accumulation in a geological region according to claim 1, wherein the geological basin model comprises mechanical stratigraphy.

5. Method of prediction of hydrocarbon accumulation in a geological region according to claim 1, wherein the geological basin model comprises the step of modeling permeability.

6. Method of prediction of hydrocarbon accumulation in a geological region according to claim 1, wherein the geological basin model further comprises at least one of the following steps of:
a. Sediment decompaction;
b. Acquisition of burial history of the geological region.

7. Method of prediction of hydrocarbon accumulation in a geological region according to claim 1, wherein the geological basin model comprises the step of modeling overpressure of the geological region.

8. Method of prediction of hydrocarbon accumulation in a geological region according to claim 1, wherein the generation of a geomechanical model further comprises at least one of the following steps of:
a. Seismic Inversion and detailed rock physics analysis including fluid substitution modelling;
b. Pre-stack Seismic Data conditioning;
c. Pre-stack AVO simultaneous inversion;
d. Prediction of mechanical properties based on porosity correlations derived from core results;
e. Generation of a 1D geomechanical model.

9. Method of prediction of hydrocarbon accumulation in a geological region according to claim 8, wherein the prediction of mechanical properties based on porosity correlations derived from core results further comprises at least one of that:
a. Porosity cubes are sourced from reservoir models;
b. In overburden and dense units separating reservoir zones, the prediction of mechanical properties is based on co- upscaled well logs; and
c. Mechanical property profiles are sourced from 1 D-geomechanics models.

10. Method of prediction of hydrocarbon accumulation in a geological region according to claim 1, further comprising the step of creating a structural model, wherein the method further comprises the step of estimating 3D static and dynamic of the geomechanics model.

11. Method of prediction of hydrocarbon accumulation in a geological region according to claim 10, comprising the step of fault and fracture analysis.

12. Method a of prediction of hydrocarbon accumulation in a geological region according to claim 11, comprising the steps of:
a. Generating a Discrete Fracture Network;
b. Upscaling the Discrete Fracture Network into the static geomechanics model.

13. Method of prediction of hydrocarbon accumulation in a geological region according to claim 10, wherein the structural model includes information about tectonic stresses in a geological region.

14. Method of prediction of hydrocarbon accumulation in a geological region according to claim 10, wherein the geological basin model and the geo-mechanical model are combined with the structural model to generate the strain maps.

15. Method of prediction of hydrocarbon accumulation in a geological region according to claim 10, wherein the structural model is combined with the integrated model.

16. Method a of prediction of hydrocarbon accumulation in a geological region according to claim 1, wherein the generation of an integrated model further comprises at least one of the following steps of:
a. 3D Mechanical Properties Population;
b. Mechanical Properties and Stress Model;
c. Pore Pressure Preparation at Selected Time-steps;
d. 3D Pre-production Stress Modelling and Calibration.

17. Method a of prediction of hydrocarbon accumulation in a geological region according to claim 16, wherein hydrocarbon accumulations are predicted from the outputs received by steps a. to d.

18. Method of prediction of hydrocarbon accumulation in a geological region according to claim 1, wherein the step of generation of strain maps comprises the following steps of:
a. Modeling of overburden stress of the geological region;
b. Modeling of effective stress of the geological region;
c. Modeling of pore stress of the geological region.

19. Method of prediction of hydrocarbon accumulation in a geological region according to claim 1, wherein the strain maps indicate regions of high and low strain.

20. Method of prediction of hydrocarbon accumulation in a geological region according to claim 1, wherein the prediction of hydrocarbon accumulation includes a delineation of areas where hydrocarbon is trapped, and a prediction of migration pathways for hydrocarbon.

21. A map indicating hydrocarbon accumulation, wherein the map is gained by a method of prediction according to claim 1.

22. A computer program product comprising instructions which, when the program is executed by a computer, cause the computer to carry out the steps of the method of claim 1.

23. A computer-readable storage medium comprising instructions which, when executed by a computer, cause the computer to carry out the steps of the method of claim 1.

24. A data processing system comprising means for carrying out the steps of the method of claim 1.
